(19) United States
(12) Patent Application Publication
(10) Pub. No.: US 2026/0085370 A1
(43) Pub. Date: Mar. 26, 2026

(54) MACHINE FOR PROCESSING LEATHER AND FABRICS

(71) Applicant: RENBERTECH S.R.L., TRISSINO (VICENZA) (IT)

(72) Inventors: Fabio GECCHELE, ARZIGNANO ( VICENZA) (IT); Manuel ZORDAN, ARZIGNANO ( VICENZA) (IT)

(73) Assignee: RENBERTECH S.R.L., TRISSINO (VICENZA) (IT)

(21) Appl. No.: 18/874,626

(22) PCT Filed: Jun. 13, 2023
(86) PCT No.: PCT/EP2023/065744

§ 371 Date: Dec. 13, 2024

(30) Foreign Application Priority Data
Jun. 15, 2022 (IT) 102022000012674

(51) Int. Cl. C14B 3/00; C14B 17/00

(52) U.S. Cl. CPC C14B 3/00; C14B 17/00; C14B 2700/27

(57) ABSTRACT

A machine, for processing leather, fabrics and the like, has a body which delimits at least one chamber for treating the leather; the chamber is accessible from the outside through at least one loading/unloading opening that can be closed by means of a door; the treatment chamber is configured to internally form a controlled-atmosphere environment that is substantially insulated with respect to the outside environment.

### The present invention relates to a machine for processing leather, fabrics, and the like.

Machines known as “milling drums” are used in tanneries in the leather finishing process. Drum milling is required to improve the softness of the leather and give it the desired final appearance. This is done by shaking actions and mechanical straining in a temperature and humidity controlled environment.

Typically, such machines are constituted by a cylindrical or prismatic enclosure, preferably made of wood, steel or plastic material, designed to contain the hides and to be turned about a substantially horizontal axis of rotation by adapted motor means.

The enclosure has an opening for loading/unloading the articles to be processed. The opening has one or more closing doors operated by adapted actuators.

US2017240982A1 discloses an apparatus and method for treating an animal skin substrate with a multiplicity of solid particles. The apparatus comprises a rotatably mounted drum for containing the animal substrate and having an outlet opening and a closure. The closure can be moveable between a first position wherein the outlet opening is closed and the animal substrate, the solid particulate material and the treatment liquor cannot pass through the outlet and are retained within the drum, and a second position wherein the outlet opening is open such that solid particulate material and the treatment liquor can exit the drum through the outlet opening. The drum has an apertured screen arranged at the outlet and configured to permit passage through the outlet opening of the solid particulate material and the treatment liquor when the closure is in the second position and to prevent passage thereof through the outlet opening of the animal skin substrate. The apertured screen is moveable from the outlet opening to permit loading and unloading of the animal skin substrate through the outlet opening when the closure is in the second position.

GB692207A discloses a drum or like container, for use in treating leather, having a doorway in the wall surface thereof through which the contents of the container can be discharged directly into a truck or other receptacle. The container has a door mounted to slide from an open to a closed position, and vice versa, between parallel guide means which are shaped to follow the contour of the outer wall surface of the container and which are secured to the latter one on each side of the doorway. A flexible inflatable tube is located in an outwardly directed channel provided around the outer rim of the doorway and is arranged on inflation when the door is closed to bear between the aforesaid channel and the marginal edge of the inner door surface, to provide a substantially liquid-tight closure of the doorway.

IT201900010665A1 discloses a machine for finishing leathers, fabrics or the like, having a container mounted on a support structure and connected to first handling means adapted to rotate the container around an axis of rotation. The container has a loading and unloading mouth which can be temporarily closed by a sliding door operated by second handling means connected to command means operated by an operator. The machine has an automatic control system for unloading the articles from the container and including detection means suitable for detecting the possible presence of articles within the range of action of the door, and electronic control devices adapted to compare the data coming from the detection means with the commands coming from the acquisition means of a closing/opening command. In the case in which the closing of the door is commanded and at the same time there is the presence of articles within the range of action of the door, the second movement means are commanded in order to block the closure of the door and the first movement means are commanded to move the container in such a way as to remove the articles from the range of action of the door.

Over the years, milling drums have evolved to become true multifunctional machines with which, in addition to the simple action of dry softening, it is possible to apply chemicals inside the milling drum to provide technical or fashion effects to the hides and skins.

However, performing these processes generally requires a large amount of water and chemical products that have to be treated before being disposed.

Moreover, some disposed products tend to be dispersed into the environment in the form of fumes and vapors that are potentially dangerous and harmful and should be removed from the production area, where personnel are present. Such removal may require expensive extraction and suppression equipment.

A further problem of conventional milling drums is their low thermal efficiency, which is a consequence of high heat loss, due to the material used for making the enclosure. The low thermal efficiency causes a high energy consumption.

The aim of the present invention is to provide a machine for finishing leather, fabrics or the like that overcomes the drawbacks of the prior art.

Within the scope of this aim, a particular object of the invention is to provide a machine that allows to substantially suppress atmospheric emissions of potentially polluting and/or toxic fumes and vapors.

A further object of the invention is to provide a machine that makes leather processing operations more sustainable, by decreasing the use of water and chemical products, and also by considerably reducing the wastewater to be purified.

A further object of the invention is to provide a machine that has high efficiency, also from the thermal standpoint, thus reducing the cost of the final product.

This aim, as well as the objects mentioned and others which will become better apparent hereinafter, are achieved by a machine for processing leather, fabrics or the like, as claimed in the appended claims.

Further features and advantages will become better apparent from the description of preferred but not exclusive embodiments of a machine according to the invention, illustrated by way of non-limiting example in the accompanying drawings, wherein:

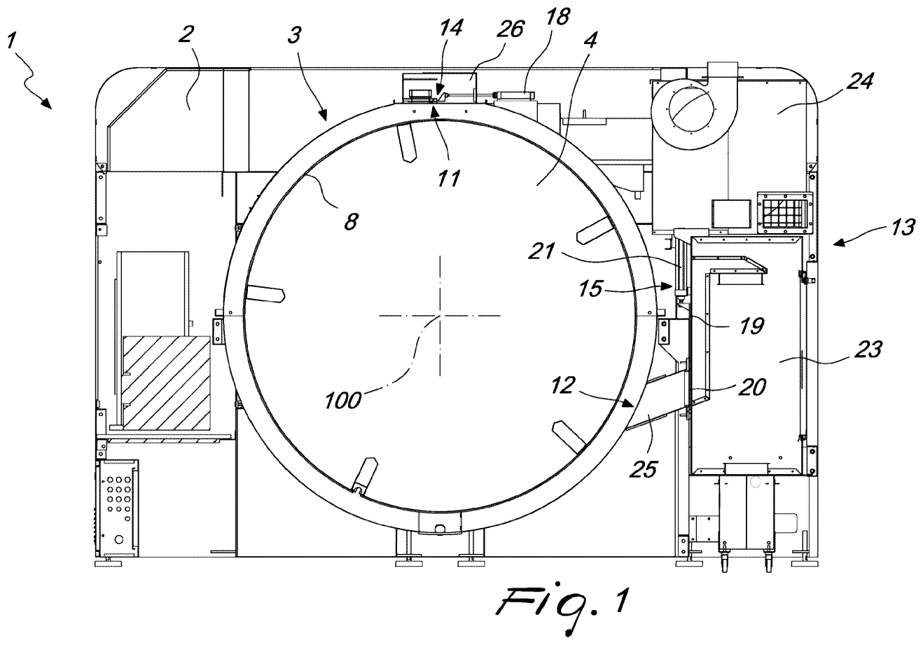

FIG. 1 is a sectional front view of a machine according to the invention;

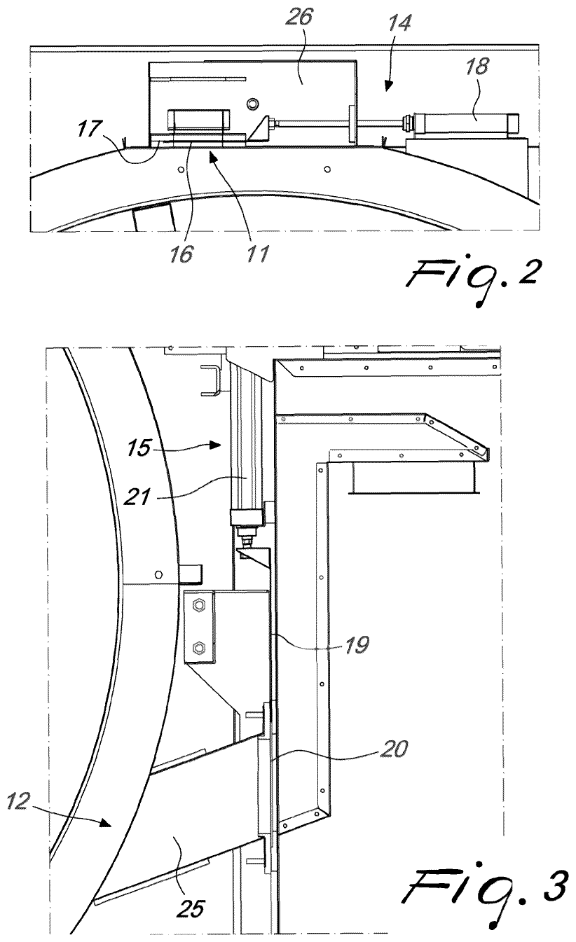

FIG. 2 is an enlarged view showing a detail of the machine of FIG. 1;

FIG. 3 is an enlarged view showing a further detail of the machine of FIG. 1;

FIG. 4 is a perspective view of the machine according to the invention;

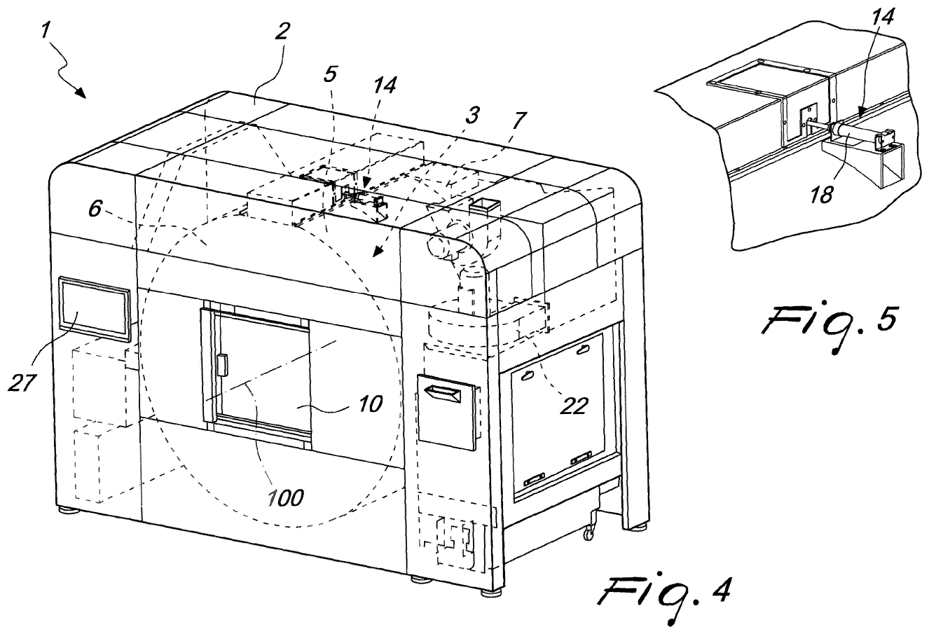

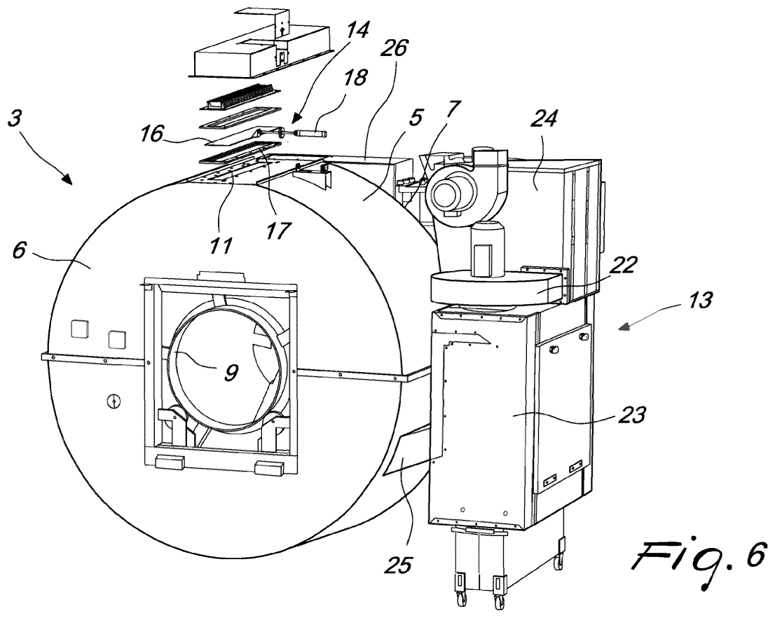

FIG. 5 is an enlarged view showing a detail of the machine of FIG. 4;

FIG. 6 is a partially exploded perspective view of the machine according to the invention;

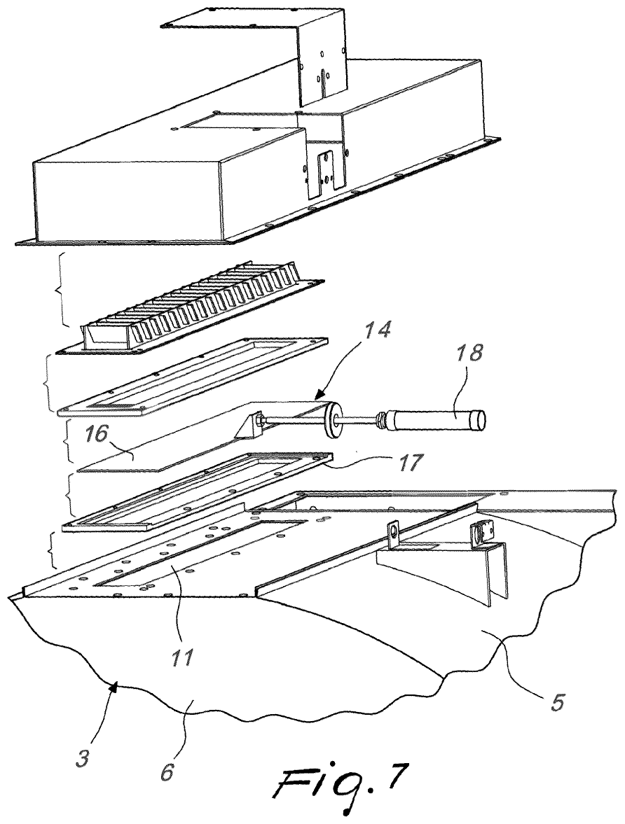

FIG. 7 is an enlarged view showing a detail of the machine of FIG. 6;

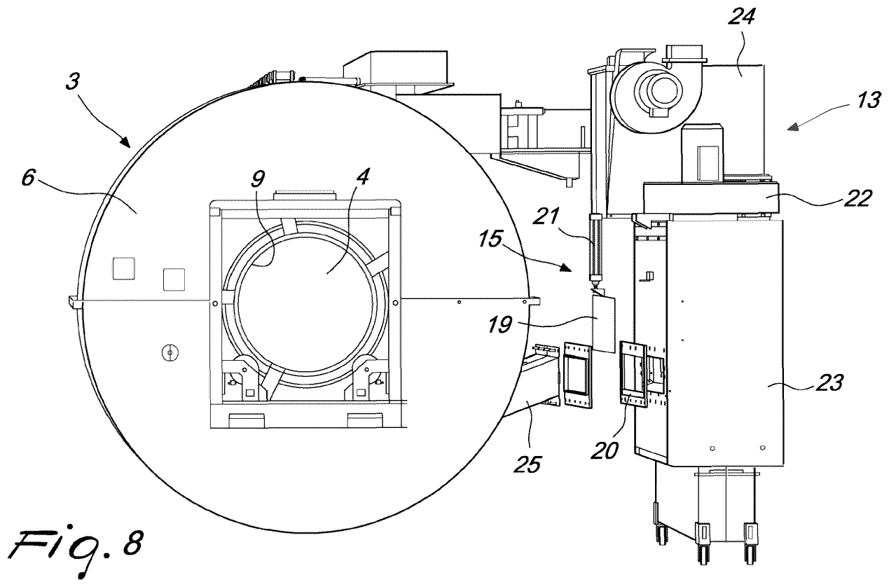

FIG. 8 is another partially exploded perspective view of the machine according to the invention;

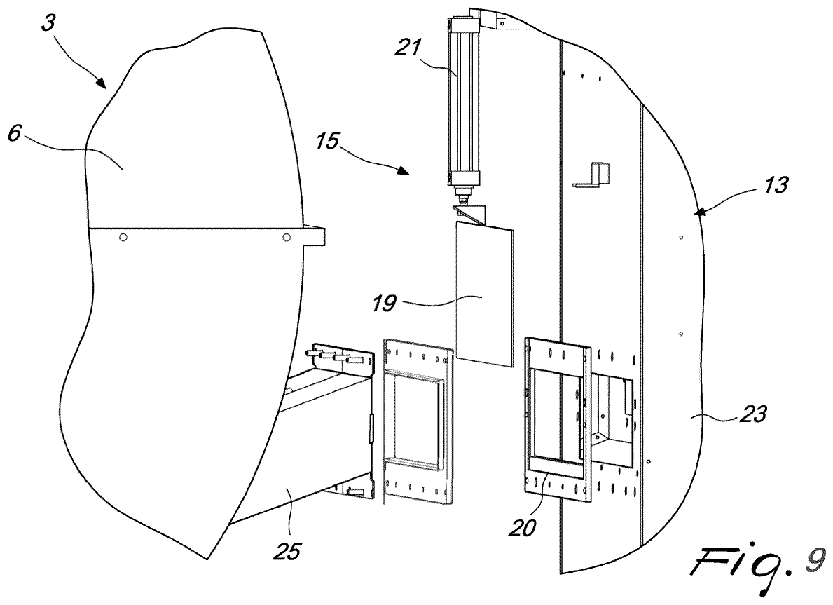

FIG. 9 is an enlarged view showing a detail of the machine of FIG. 8.

With reference to the cited figures, a machine for processing leather, fabrics or the like, generally designated by the reference numeral 1, has a supporting structure 2 supporting a body 3 forming an inner treatment chamber 4 suitable for performing mechanical or chemical treatments on hides or fabrics.

In the example shown, the body 3 has a cylindrical wall 5, with a substantially horizontal axis 100, closed at both ends by flat walls 6, 7.

A drum 8 is arranged inside the body 3, which is stationary. The drum 8 rotates about an axis 100. The articles to be treated by the machine 1 are placed in the drum 8.

As apparent to the person skilled in the art, the body 3 may have constructive features different from those described and shown; for example, the body 3 may have a polygonal or mixtilinear transverse profile, and/or may be integral with the drum 8, so as to form a unit which can rotate about the axis 100.

The treatment chamber 4 is accessible from the outside through a loading/unloading opening 9 which is preferably provided on the front part of the machine 1 and can be closed by means of a door 10 associated with the supporting structure 2, for example in a sliding manner.

According to the present invention, the treatment chamber 4 is configured so as to form a controlled-atmosphere environment inside the treatment chamber. The controlled-atmosphere environment is substantially insulated from the outside environment and the level of ventilation, temperature and humidity are maintained at optimum values for each specific process performed by the machine 1.

The treatment chamber 4 has at least one intake opening 11 and at least one discharge opening 12 through which a flow of air, preferably arriving from an air treatment unit 13, can pass.

Preferably, the aperture of the intake opening 11 and of the discharge opening 12 are adjustable by means of a first flow control element 14 and by a second flow control element 15 respectively, which are movable on command between at least one open position, in which they allow the transit of the air flow through the treatment chamber 4, and at least one closed position, in which they instead prevent the transit of the air flow.

The first and second flow control elements 14, 15 and the door 10, when closed, are capable of completely and substantially hermetically insulate the treatment chamber 4 from the outside environment.

In the example shown, the first flow control element 14 has a first closure plate 16 which is adapted to slide in a first seat 17 formed with the body 3, substantially at the intake opening 11.

The first closure plate 16 is movable between the open position and the closed position by means of a first actuation means 18, which is, for example, a linear actuator.

Likewise, the second flow control element 15 is constituted by a second closure plate 19 which is adapted to slide within a second seat 20 formed in the body 3, substantially at the discharge opening 12.

The second closure plate 19 is movable between the open position and the closed position by means of a second actuation means 21, which is, for example, a linear actuator.

It is apparent to the person skilled in the art that the first and second flow control elements 14, 15 may have different constructive features without departing from the invention; for example, the first and second flow control elements 14, 15 may be constituted by closure doors hinged at one end to the body 3, respectively at the intake opening 11 and at the discharge opening 12, and are operated by means of a first actuation means 18 and the second actuation means 21.

Advantageously, the machine 1 includes a temperature and humidity control means for controlling the temperature and humidity inside the treatment chamber 4.

The temperature and humidity control means is advantageously constituted by the air treatment unit 13 mentioned above.

The term “control” means the ability to measure and adjust the temperature and/or humidity in the treatment chamber 4 by acting on the corresponding parameters.

In this way, it is possible to maintain the temperature and/or humidity level on the optimal values for the particular processes performed by the machine 1.

The air treatment unit 13 comprises an intake/delivery fan 22, an air filter 23 and a heat exchange assembly 24. The air treatment unit 13 is connected to the treatment chamber 4 via an intake duct 25 and a delivery duct 26 that flow into the discharge opening 12 and the intake opening 11, respectively.

Preferably, temperature and humidity parameters are managed by means of an electronic control unit 27, which substantially controls the entire machine 1, in addition to controlling the air treatment unit 13.

Control of the temperature and humidity inside the treatment chamber 4 is improved by a thermal insulation means associated with the walls of the body 3, for example in the form of thermally insulating panels arranged on the outer face of the walls.

Advantageously, the machine 1 includes a dispenser means for dosing water and/or chemical products inside the treatment chamber 4. The dispenser means is constituted, for example, by a plurality of nozzles, not shown in the figures, which nebulize/atomize these products into droplets that are absorbed by the leather in a uniform and cohesive manner.

At least part of the vapors produced inside the treatment chamber 4 by the water and/or chemical product dispensing means, once they have performed their function, pass to a condensation and recovery means, not shown in the figures, which converts the vapors into liquid that is collected and purified, for example by filtration and decantation, so that it can be at least partially recycled within the processes performed by the machine 1.

In this way, only a very small part of the water of the aqueous solution used by the machine 1 is then disposed of at civil wastewater treatment plants.

The operation of the machine according to the invention is apparent from what has been described and shown.

Namely, the articles to be processed by the machine 1, particularly hides, are fed into the treatment chamber 4 through the loading/unloading opening 9, after which the door 10 is closed and the treatment process is then started.

During some steps of the process, a controlled-atmosphere environment is created inside the treatment chamber 4, also by the action of the air treatment unit 13 which generates a flow of appropriately treated air between the intake opening 11 and the discharge opening 12.

If necessary, the air treatment chamber 4 is almost hermetically insulated from the outside environment by moving the first and second flow control elements 14, 15 to the closed position.

The articles contained in the treatment chamber 4 can be sprayed with water and adapted chemical products that are preferably atomized by means of the dispenser means mentioned above.

The spent and/or excess liquid can be recovered by the condensation and recovery means, so that it can be at least partially recycled.

The invention achieves the intended aim and objects providing a machine for processing leather, fabrics and the like which, by creating inside it a controlled-atmosphere environment that can be insulated completely from the external environment, does not emit potentially polluting and/or toxic fumes and vapors.

Also, the machine according to the invention allows to minimize the consumption of water and electric power for its operation.

A further advantage of the machine according to the invention is that it has a high thermal efficiency.

This application claims the priority of Italian Patent Application No. 102022000012674, filed on Jun. 15, 2022, the subject matter of which is incorporated herein by reference.

1-12. (canceled)

13. A machine for processing items such as leather and fabrics comprising a body delimiting at least one treatment chamber; said treatment chamber being accessible from the outside environment through at least one loading/unloading opening; said opening having a door; said machine wherein said treatment chamber forms a controlled-atmosphere environment containing said items; said treatment chamber being insulated from the outside environment.

14. The machine according to claim 13, wherein said treatment chamber comprises at least one air intake opening and at least one air discharge opening; said air intake and discharge openings respectively having a first flow control element and a second flow control element that are movable on command between at least one open position and at least one closed position, wherein they respectively allow or prevent a flow of air through said treatment chamber.

15. The machine according to claim 13, wherein said treatment chamber is substantially hermetic with respect to the outside environment when said first and second flow control elements are in the closed position and said loading/unloading opening is closed by said door.

16. The machine according to claim 13, wherein said first flow control element comprises a first closure plate sliding in a first seat associated with said body substantially at said air intake opening; said first closure plate being movable between said open position and said closed position by means of a first actuation means.

17. The machine according to claim 13, wherein said first flow control element comprises a first closure door hinged at one end of said body, at said air intake opening; said first closure door being movable between said open position and said closed position by means of said first actuation means.

18. The machine according to claim 13, wherein said second flow control element comprises a second closure plate sliding in a second seat associated with said body, at said air discharge opening; said second closure plate being movable between said open position and said closed position by virtue of a second actuation means.

19. The machine according to claim 13, wherein said second flow control element comprises a second closure door hinged at one end to said body, at said air discharge opening; said second closure door being movable between said open position and said closed position by virtue of said second actuation means.

20. The machine according to claim 13, wherein treatment chamber comprises a thermal insulation means thermally insulating said controlled-atmosphere environment from the outside environment.

21. The machine according to claim 13, wherein it comprises a temperature and humidity control means controlling the internal temperature of said treatment chamber and/or the internal humidity of said treatment chamber.

22. The machine according to claim 13, wherein it comprises a dispenser means dosing water and/or chemical products inside said treatment chamber.

23. The machine according to claim 13, wherein it comprises a condensation and recovery means condensing and recovering the vapors that are released in said treatment chamber.

24. The machine according to claim 13, wherein it comprises a rotating drum arranged inside said treatment chamber.
